(19) United States
(12) Patent Application Publication
(10) Pub. No.: US 2026/0170804 A1
(43) Pub. Date: Jun. 18, 2026

(54) DEVICE AND COMPUTER-IMPLEMENTED METHOD FOR CLASSIFYING A DIGITAL CONTENT

(71) Applicant: Robert Bosch GmbH, Stuttgart (DE)

(72) Inventors: Tim Lucca Tarsi, Pleidelsheim (DE); Annemarie Friedrich, Grossaitingen (DE); Heike Adel-Vu, Renningen (DE)

(21) Appl. No.: 19/129,318

(22) PCT Filed: Feb. 16, 2024
(86) PCT No.: PCT/EP2024/053990

§ 371 Date: May 13, 2025

(30) Foreign Application Priority Data
Feb. 17, 2023 (DE) 10 2023 201 382.7

(51) Int. Cl. G06V 10/764

(52) U.S. Cl. CPC G06V 10/764

(57) ABSTRACT

A device and a computer-implemented method for classifying a digital content, in particular a digital image. A first classifier is used to determine, for the digital content (102) from a set of classes, a class with a precision assigned to this class. Depending on the precision, either the class determined using the first classifier is output for classifying the digital content, or a second classifier is used to determine a class from a proper subset of the set of classes that includes at least two classes from the set of classes. The proper subset including the class determined using the first classifier. The class determined using the second classifier is output for classifying the digital content.

### FIELD

The present invention relates to a device and a computer-implemented method for classifying a digital content, in particular a digital image.

### SUMMARY

The device and the computer-implemented method for classifying digital content, in particular a digital image, according to certain features of the present invention, achieve an improvement of the classification.

According to an example embodiment of the present invention, the computer-implemented method for classifying a digital content, in particular a digital image, provides that a first classifier is used to determine, for the digital content from a set of classes, a class with a precision assigned to this class, wherein, depending on the precision, either the class determined using the first classifier is output for classifying the digital content, or a second classifier is used to determine a class from a proper subset of the set of classes that comprises at least two classes from the set of classes, wherein the proper subset comprises the class determined using the first classifier, and wherein the class determined using the second classifier is output for classifying the digital content. Depending on the precision, a single-layer or a multilayer classification is determined first via the set and then via the subset. The first classifier distinguishes the classes from the set of classes. The second classifier distinguishes the classes from the subset. This provides a better overall classification result.

According to an example embodiment of the present inventio, digital contents are preferably provided, wherein the first classifier is used to determine a prediction for the classifier for each digital content, wherein, depending on the predictions for the digital contents, a value is determined for a class from the set of classes, which characterizes the precision of the prediction for this class, wherein this class is selected or not selected for the proper subset depending on the value determined for that class. The classes predicted with higher precision are separated from the classes with lower precision depending on the value. Classes with higher precision are accepted, classes with lower precision are reclassified.

According to an example embodiment of the present invention, a class from the set is preferably checked to determine whether the value indicates a precision that is less than a threshold value, wherein the second classifier is provided with this class if the precision is less than the threshold value. This means that the second classifier is used for the class if the precision of the first classifier is too low. This improves the classification.

The proper subset for the second classifier preferably comprises the class determined with the first classifier and at least one further class from the set of classes for which the first classifier selects this class determined with the first classifier with a specific frequency, in particular more frequently than for at least one other class. The class determined by the first classifier represents a base class. The second classifier takes into account the base class and another class for which the prediction with the first classifier selects the base class, but for which the classifier should correctly select the other class. The second classifier is provided in the simplest case to distinguish between the base class and the other class. The second classifier can also be provided to distinguish the base class from a plurality of other classes, e.g. classes other than the base class, for which the first classifier predicts the base class incorrectly more often than for other classes from the set of classes.

According to an example embodiment of the present invention, the first classifier is preferably trained independently of the second classifier. The second classifier is preferably trained independently of the first classifier.

In one example embodiment of the present invention, the first classifier and the second classifier are trained with the same digital content.

In one example embodiment of the present invention, it is provided that the first classifier is trained with digital content from the set of classes, and the second classifier is trained with digital content from the subset of classes. This means that the first classifier is trained to distinguish the classes from the set of classes. This means that second classifier is trained to distinguish the classes from the subset.

According to an example embodiment of the present invention, it is preferably provided that a digital content, in particular a digital image, a digital text or an object represented as a vector, is mapped to an embedding using an encoder, in which case the first classifier is trained to map the embedding to one value per class from the set of classes and/or the embedding is mapped to one value per class from the set of classes using the first classifier. The encoder provides the embedding for classification.

According to an example embodiment of the present invention, it is preferably provided that the second classifier is trained to map an embedding of a digital image to one value per class from the proper subset of classes and/or that an embedding is mapped to one value per class from the proper subset of classes using the second classifier. This means that second classifier uses an embedding like the first classifier.

According to an example embodiment of the present invention, it is preferably provided that the first classifier and the second classifier are preferably trained with the same embedding and/or that the same embedding is mapped with the first classifier and the second classifier. Caching the embeddings saves other computing resources.

In one example embodiment of the present invention, a plurality of classifiers are provided, which comprise the first classifier and a set of second classifiers for different proper subsets of the set of classes, wherein the different proper subsets are each assigned to a class from the set of classes, wherein the class is determined using either the first classifier or one of the second classifiers depending on the precision, wherein the second classifier with which the class is determined is selected from the set of classifiers depending on the class determined using the first classifier.

According to an example embodiment of the present invention, the device for classifying the digital content comprises at least one processor and at least one memory on which instructions that can be executed by at least one processor are stored, the execution of which by at least one processor causes the method of the present invention to run.

The program for classifying a digital content comprises instructions that can be executed by at least one processor, the execution of which by at least one processor causes the method of the present invention to run.

Further advantageous embodiments of the present invention will become apparent from the following description and the figures.

### BRIEF DESCRIPTION OF THE DRAWINGS

FIG. 1 shows a schematic illustration of a device for classifying a digital content, according to an example embodiment of the present invention.

FIG. 2 shows a schematic illustration of an architecture for classifying a digital content, according to an example embodiment of the present invention.

FIG. 3 shows a flow chart showing steps of a method for classifying a digital content, according to an example embodiment of the present invention.

FIG. 4 shows a flow chart showing steps of a method for training classifiers, according to an example embodiment of the present invention.

### DETAILED DESCRIPTION OF EXAMPLE EMBODIMENTS

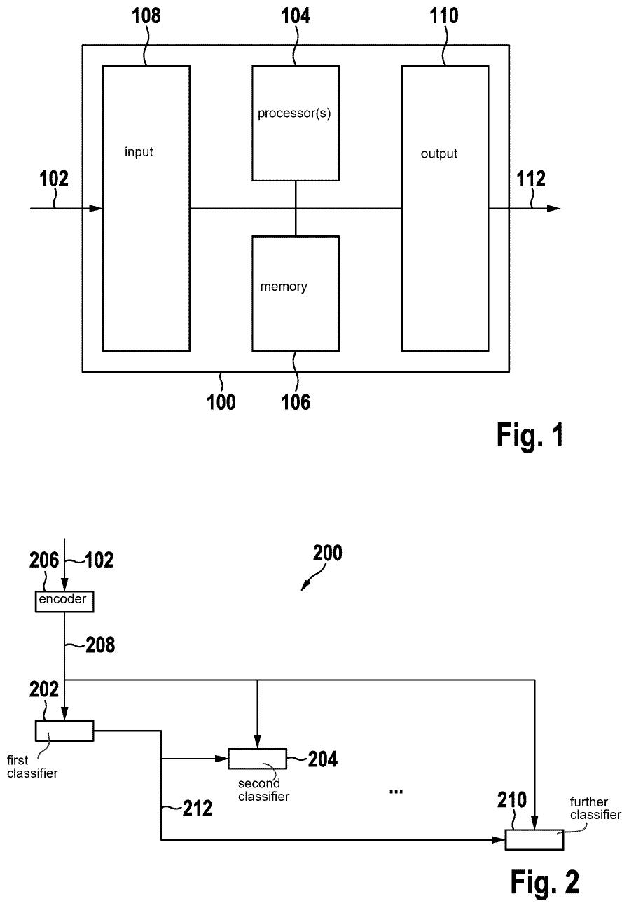

FIG. 1 schematically shows a device 100 for classifying a digital content 102.

Digital content 102 is, for example, data that are created and provided in digital form. Examples of this are a digital image, a photo or video file, a music file, a computer program, a digital game, digital text, an electronic book or an object represented as a vector.

The device 100 comprises at least one processor 102 and at least one memory 106. In the example, the device 100 includes an input 108 configured to receive the digital content 102. In the example, the device includes an output 110 configured to output a class 112 for classifying the digital content 102.

Instructions that can be executed by the at least one processor 104 are stored on the at least one memory 106.

The execution of the instructions by the at least one processor 104 causes the method for classifying a digital content to run.

A program for classifying a digital content comprises instructions that can be executed by at least one processor 104, the execution of which by at least one processor 104 causes the method to run.

FIG. 2 schematically shows an architecture 200 for classifying the digital content 102.

The architecture 200 comprises a first classifier 202 and a second classifier 204. In the example, the architecture 200 comprises an encoder 206 that is configured to map the digital content 102 to an embedding 208.

It can be provided that the architecture 200 comprises one further classifier 210 or a plurality of further classifiers.

In the example, the class 112 output for the classification of the digital content 102 is determined either by means of the prediction of the first classifier 202 for the class 112 or by means of the prediction the second classifier 204 for the class 112. Which of the predictions is output as the class 112 is determined in the example depending on a precision 212 of the prediction of the first classifier 202 for the class 112. This means that the class 112 is determined using either the first classifier 202 or the second classifier 204.

If at least one further classifier 210 is provided, it can be provided that the class 112 is determined using either the first classifier 202 or the second classifier 204 or the further classifier 210 or one of the further classifiers depending on the precision 212 of the prediction of the first classifier 202 for the class 112.

The architecture 200 is implemented as an artificial neural network with an input layer for an input that characterizes the digital content 102, for instance. The encoder 208 comprises a fully connected layer, for example. The classifiers each comprise a fully connected layer, for example. The neural network comprises an output for the class 112, for example.

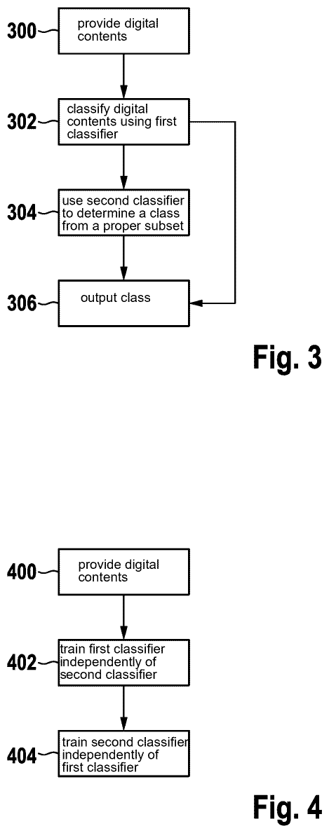

FIG. 3 shows a flow chart with the steps of the method for classification.

The method comprises a step 300.

In step 300, digital contents are provided. In step 300, the digital contents are mapped to their respective embedding using the encoder 206.

For example, the digital content 102 is mapped to its embedding 208 using the encoder 206.

The method comprises a step 302.

In step 302, the digital contents are classified using the first classifier 202. In step 302, a prediction for a class from the set of classes is determined for each digital content using the first classifier 202, for example.

For the digital content 102, for instance, a class from the set of classes is determined using the first classifier 202.

In the example, the embedding 208 is mapped to a class using the first classifier 202.

The embedding 208 of the digital content 102 is mapped to one value per class from the set of classes using the first classifier 202, for example.

The class is determined with a precision 212 assigned to this class.

For example, depending on the predictions for the digital contents, a value is determined for each class that characterizes the precision 212 of the prediction for this class.

Depending on the precision 212, either a step 304 or a step 306 is carried out.

In step 304, the second classifier 204 is used to determine a class from a proper subset of the set of classes.

The embedding 208 of the digital content 102 is mapped to one value per class from the proper subset of classes using the second classifier 204, for example.

In one embodiment, the proper subset includes the class determined with the first classifier 202 as the base class and at least one class from the set of classes that the first classifier 202 predicts incorrectly more often than other classes or most often.

The proper subset includes the base class and one other or a plurality of other classes. The selection of the other class is described in the following. If other classes are selected, this is done as described for the one other class, for example.

The decisive factor for the selection of the other class in the example is that many of the false positive predictions of the first classifier 202, i.e. the predictions for which the first classifier 202 predicts the base class, actually belong to the other class.

The base class of the second classifier 204 is determined depending on the precision of the first classifier 202. The other class is determined depending on a comparison of the predictions of the first classifier 202 with a respective actually to be predicted class, for instance.

For possible classes a, b, c, for example, an evaluation of the incorrect predictions is evaluated using a confusion matrix that indicates a frequency of correct and incorrect predictions for a*, b*, c* depending on the class a, b, c actually assigned to the digital images.

An example of this for the actual class a is an eight-fold occurrence of a correct prediction, a two-fold occurrence of an incorrect prediction of b instead of a, and a three-fold occurrence of an incorrect prediction of c instead of a.

An example of this for the actual class b is a sixteen-fold occurrence of a correct prediction, a two-fold occurrence of an incorrect prediction of a instead of b, and a five-fold occurrence of an incorrect prediction of c instead of b.

An example of this for the actual class c is a seven-fold occurrence of a correct prediction, no occurrence of an incorrect prediction of a instead of c, and a two-fold occurrence of an incorrect prediction of b instead of c.

This means that the precision for the class a is 0.8, for the class b it is 0.8 and for the class c it is 0.47.

This means that, for a threshold value of 0.7, for example, the result of the first classifier 202 is used for the classes a and b, in which case the proper subset for the second classifier 204 is {c, b}.

The proper subset {c, b} of the set of classes includes at least two classes from the set of classes a, b, c. The proper subset includes the class c determined using the first classifier 204, the precision of which is less than the threshold value.

If the further classifier 210 or further classifiers are provided, in one embodiment the classifier used to determine the class from the proper subset is selected.

It can be provided that a set of classifiers is provided that comprises different classifiers for different proper subsets.

It can be provided that the classifier is selected from the set that is configured to select the class from the proper subset.

The classes for the proper subset are determined depending on the values determined for the classes, for example.

The subset includes at least two classes from the set of classes.

The subset includes the class determined using the first classifier 204.

In step 306, either the class determined using the first classifier 202 or the class determined using the second classifier 204 is output as the class 112 for classifying the digital content 102.

FIG. 4 shows a flow chart with the steps of a method for training classifiers.

The method for training optionally comprises a step 400. Step 400 provides that digital contents are provided.

Step 400 provides that the digital contents are mapped to their embedding using the encoder 206.

For example, the digital content 102 is mapped to its embedding 208 using the encoder 206.

The method for training comprises a step 402.

In step 402, the first classifier 202 is trained independently of the second classifier 204. In the example, the first classifier 202 is trained using digital content from the set of classes.

The first classifier 202 is trained to map one embedding to one value per class from the set of classes, for example.

The first classifier 202 is trained to map the embedding 208 of the digital content 102 to one value per class from the set of classes using the first classifier 202, for example.

The method for training comprises a step 404.

In step 404, the second classifier 204 is trained independently of the first classifier 202. In the example, the second classifier 204 is trained using digital content from the subset of classes.

The second classifier 204 is trained to map one embedding to one value per class from the subset of classes, for example.

The second classifier 204 is trained to map the embedding 208 of the digital content 102 to one value per class from the proper subset of classes using the second classifier 204, for example.

It can be provided that the first classifier 202 and the second classifier 204 are trained with the same digital content.

It can be provided that the first classifier 202 and the second classifier 204 are trained for the digital content 102 with the same embedding 208. It can be provided that the same embedding 208 is mapped using the first classifier 202 and the second classifier 204.

This means that the embedding 208 is determined only once, for example.

It can be provided that the further classifier 410 or plurality of classifiers are trained to classify different proper subsets of the set of classes.

In one embodiment, a plurality of classifiers, in particular a cascade of a plurality of classifiers, are provided, which include the first classifier 202 and a set of second classifiers 204 for different proper subsets of the set of classes. The different proper subsets are each assigned to a class, i.e. a base class, from the set of classes.

Depending on the precision 212, the class 112 is determined using either the first classifier 202 or one of the second classifiers 204.

If the class 112 is predicted by the first classifier 202 with too low a precision 212, the second classifier 204 with which the class 112 is determined is selected from the set of classifiers depending on the class determined with the first classifier 202, i.e. the base class.

It can be provided that the encoder 206 is trained in an upstream step or is included in the training. The encoder preferably includes parameters that are pretrained and remain unchanged during the training of the classifiers.

For an inference, the first classifier 202 is used to determine the class, i.e. the base class, for a digital content 102. If no other classifier is provided for this base class, the class 112 is determined using the first classifier 202.

If a second classifier 204 from the set of classifiers assigned to the base class is provided for this base class, this second classifier 204 is used in the inference to determine the class 112.

This means that, depending on the precision 212 determined in the training, in the inference either the class determined for the digital content 102 using the first classifier 202 is output for classifying the digital content 102 or the class determined for the digital content 102 using the second classifier is output for classifying the digital content 102.

In one embodiment, the first classifier 202 is used first for the inference. If it predicts a class that had too low a precision 212 in training, the instance is then reclassified using the second classifier 204 assigned to this predicted class. This means that the first classifier 202 and the second classifier 204 form a cascade, wherein the class predicted using the second classifier 204 represents the final decision of the cascade, i.e. the class 112 that is output.

1-13. (canceled)

14. A computer-implemented method for classifying a digital content including a digital image, the method comprising the following steps:
using a first classifier to determine, for the digital content from a set of classes, a class with a precision assigned to this class;
depending on the precision, choosing between the following steps to perform: (i) outputting the class determined using the first classifier for classifying the digital content, and (ii) using a second classifier to determine a class from a proper subset of the set of classes that including at least two classes from the set of classes, wherein the proper subset includes the class determined using the first classifier, and outputting the class determined using the second classifier is output for classifying the digital content; and performing the chosen step.

15. The method according to claim 14, wherein digital contents are provided, wherein the first classifier is used to determine a prediction for a class for each digital content of the provided digital contents, wherein, depending on the predictions for the digital contents, a value is determined for a class from the set of classes, which characterizes the precision of the prediction for the class, wherein this class is selected or not selected for the proper subset depending on the value determined for that class.

16. The method according to claim 15, wherein the class from the set is checked to determine whether the value indicates a precision that is less than a threshold value, wherein the second classifier is provided with the class when the precision is less than the threshold value.

17. The method according to claim 14, wherein the proper subset for the second classifier includes the class determined with the first classifier and at least one further class from the set of classes for which the first classifier selects the class determined with the first classifier with a specific frequency that is more frequent than for at least one other class.

18. The method according to claim 14, wherein the first classifier is trained independently of the second classifier and/or the second classifier is trained independently of the first classifier.

19. The method according to claim 14, wherein the first classifier and the second classifier are trained with the same digital contents.

20. The method according to claim 14, wherein the first classifier is trained with digital images from the set of classes, and the second classifier is trained with digital images from the proper subset of classes.

21. The method according to claim 14, wherein: the digital content is mapped to an embedding using an encoder, wherein: (i) the first classifier is trained to map the embedding to one value per class from the set of classes and/or (ii) the embedding is mapped to one value per class from the set of classes using the first classifier.

22. The method according to claim 14, wherein: (i) the second classifier is trained to map an embedding of the digital content to one value per class from the proper subset of classes, and/or (ii) the second classifier is used to map an embedding to one value per class from the proper subset of classes.

23. The method according to claim 21, wherein the first classifier and the second classifier are trained with the same embedding and/or that the same embedding is mapped with the first classifier and the second classifier.

24. The method according to claim 14, wherein a plurality of classifiers are provided which comprise the first classifier and a set of second classifiers for different proper subsets of the set of classes, wherein different proper subsets are each assigned to a class from the set of classes, wherein the class is determined using a choice between the first classifier and one of the second classifiers depending on the precision, wherein the second classifier with which the class is determined is selected from the set of classifiers depending on the class determined using the first classifier.

25. A device for classifying a digital content including a digital image, the device comprising:
at least one processor; and
at least one memory on which are stored instructions that can be executed by at least one processor, wherein execution of the stored instructions by at least one processor of the at least one processor causing the at least one processor to classify a digital content including a digital image, by performing the following steps:
using a first classifier to determine, for the digital content from a set of classes, a class with a precision assigned to this class;
depending on the precision, choosing between the following steps to perform: (i) outputting the class determined using the first classifier for classifying the digital content, and (ii) using a second classifier to determine a class from a proper subset of the set of classes that including at least two classes from the set of classes, wherein the proper subset includes the class determined using the first classifier, and outputting the class determined using the second classifier is output for classifying the digital content; and performing the chosen step.

26. A non-transitory computer-readable medium on which is stored a program for classifying a digital content including a digital image, the program, when executed by at least one processor, causing the at least one processor to perform the following steps:
using a first classifier to determine, for the digital content from a set of classes, a class with a precision assigned to this class;
depending on the precision, choosing between the following steps to perform: (i) outputting the class determined using the first classifier for classifying the digital content, and (ii) using a second classifier to determine a class from a proper subset of the set of classes that including at least two classes from the set of classes, wherein the proper subset includes the class determined using the first classifier, and outputting the class determined using the second classifier is output for classifying the digital content; and performing the chose step.
